(19) United States
(12) Patent Application Publication
(10) Pub. No.: US 2025/0065869 A1
(43) Pub. Date: Feb. 27, 2025

(54) Vehicle Control Apparatus and Method Thereof

(71) Applicants: Hyundai Motor Company, Seoul (KR); Kia Corporation, Seoul (KR)

(72) Inventors: In Ho Kim, Seoul (KR); Kyoung Jun Lee, Seoul (KR)

(21) Appl. No.: 18/532,506

(22) Filed: Dec. 7, 2023

(30) Foreign Application Priority Data
Aug. 24, 2023 (KR) 10-2023-0111400

(51) Int. Cl. B60W 30/14

(52) U.S. Cl. CPC B60W 30/143; B60W 2520/10; B60W 2552/05; B60W 2552/10; B60W 2552/20; B60W 2555/60; B60W 2720/106

(57) ABSTRACT

Disclosed is a vehicle control apparatus which includes memory and a controller. The vehicle control apparatus may obtain road information about a road on a driving route based on a determination that a driving route of a vehicle includes a tollgate, determine a target speed based on the road information, and control the vehicle to travel at a target rate of acceleration. The target rate of acceleration may be determined based on the target speed, a current driving speed of the vehicle, and/or a distance from the vehicle to the tollgate.

### CROSS-REFERENCE TO RELATED APPLICATION

This application claims the benefit of priority to Korean Patent Application No. 10-2023-0111400, filed in the Korean Intellectual Property Office on Aug. 24, 2023, the entire contents of which are incorporated herein by reference.

### TECHNICAL FIELD

The present disclosure relates to a vehicle control apparatus and a method thereof, and relates more particularly to controlling a driving speed of a vehicle.

### BACKGROUND

As autonomous driving or smart cruise control (e.g., adaptive cruise control) is more widely adopted in vehicles, many technical advances have been made in this area of technology. For example, autonomous driving may be further categorized into partial autonomous driving, conditional autonomous driving, high autonomous driving, and/or full autonomous driving, depending on its level of control.

Meanwhile, various types of control algorithms (or functions) for driving control of an ego vehicle (e.g., a vehicle that is being driven autonomously) have been developed.

### SUMMARY

The present disclosure has been made to solve the above-mentioned problems occurring in the prior art while advantages achieved by the prior art are maintained intact.

An aspect of the present disclosure provides a vehicle control apparatus for providing a function of identifying required deceleration based on road property information about the road and controlling a driving speed of an ego vehicle, when there is a tollgate on a driving route of the ego vehicle.

Another aspect of the present disclosure provides a vehicle control apparatus for receiving tollgate information including a location of a tollgate and/or road property information from a navigation device using a communication device and identifying whether there is a tollgate or a target speed using at least some of the pieces of received information.

Another aspect of the present disclosure provides a vehicle control apparatus for identifying a target speed for driving speed control of an ego vehicle based on a different method depending on whether there is a curved section within a specified distance from a tollgate.

Another aspect of the present disclosure provides a vehicle control apparatus for identifying a lane number change rate before and after an ego vehicle enters a tollgate, when there is no curved section within a specified distance from the tollgate and identifying a target speed based on a deceleration weight identified in response to a predetermined safe speed and the lane number change rate.

Another aspect of the present disclosure provides a vehicle control apparatus for identifying a target speed for driving speed control of an ego vehicle based on a different method depending on whether there is a curved section after the ego vehicle passes through the tollgate, when there is the curved section within a specified distance from the tollgate.

Another aspect of the present disclosure provides a vehicle control apparatus for setting a target speed to a predetermined safe speed and controlling a driving speed of an ego vehicle, when there is a curved section after the ego vehicle passes through a tollgate, and setting a smaller value between an exit speed of the curved section and a predetermined safe speed to a target speed and performing driving control of the ego vehicle, when there is the curved section before the ego vehicle passes through the tollgate.

The technical problems to be solved by the present disclosure are not limited to the aforementioned problems, and any other technical problems not mentioned herein will be clearly understood from the following description by those skilled in the art to which the present disclosure pertains.

According to one or more example embodiments of the present disclosure, a vehicle control apparatus may include: a controller and memory. The memory may store instructions that, when executed by the controller, cause the vehicle control apparatus to: obtain, based on a determination that a driving route of a vehicle includes a tollgate, road information about a road on the driving route; determine, based on the road information, a target speed for driving control of the vehicle; and control the vehicle to travel at a target rate of acceleration. The target rate of acceleration may be determined based on at least one of: the target speed, a current driving speed of the vehicle, or a distance from the vehicle to the tollgate.

The vehicle control apparatus may further include a communication device. The instructions, when executed by the controller, may further cause the vehicle control apparatus to: receive, from a navigation device via the communication device, an indication of a location of the tollgate; and determine, based on the location of the tollgate, that the driving route includes the tollgate.

The instructions, when executed by the controller, may cause the vehicle control apparatus to obtain the road information by receiving the road information from the navigation device via the communication device.

The road information may include information about at least one of: a curved section in the driving route, or a number of lanes in the driving route.

The instructions, when executed by the controller, may further cause the vehicle control apparatus to: determine, based on the road information indicating a lack of curved section in the driving route within a threshold distance away from the tollgate, a lane change ratio between a first quantity of lanes, before a lane change location, and a second quantity of lanes after the lane change location. The instructions, when executed by the controller, may cause the vehicle control apparatus to determine the target speed further based on an acceleration multiplier. The acceleration multiplier may be based on a posted speed limit and the lane change ratio.

The instructions, when executed by the controller, may further cause the vehicle control apparatus to store a mapping table that maps the lane change ratio to the acceleration multiplier. The instructions, when executed by the controller, may further cause the vehicle control apparatus to: determine the acceleration multiplier to be inversely proportional to the lane change ratio; and determine the target speed based on the acceleration multiplier and the posted speed limit.

The instructions, when executed by the controller, may cause the vehicle control apparatus to determine the target speed by: based on the road information indicating that there is a curved section after the tollgate and within a threshold distance away from the tollgate, setting the target speed to a posted speed limit.

The instructions, when executed by the controller, may cause the vehicle control apparatus to determine the target speed by: based on the road information indicating that there is a curved section before the tollgate and within a threshold distance away from the tollgate, setting the target speed to be a smaller value of: an exit speed of the curved section, and a posted speed limit.

The target rate of acceleration may be a first target rate of acceleration. The instructions, when executed by the controller, may cause the vehicle control apparatus to control the vehicle to travel at the first target rate of acceleration further based on the distance from the vehicle to the tollgate being within a first threshold distance.

The instructions, when executed by the controller, may further cause the vehicle control apparatus to: based on the distance from the vehicle to the tollgate being within a second threshold distance that is less than the first threshold distance, control the vehicle to travel at a second target rate of acceleration. The second target rate of acceleration may be determined based on at least one of: the target speed, the current driving speed of the vehicle, or a control gain.

According to one or more example embodiments of the present disclosure, a vehicle control method may include: obtaining, by a controller and based on a determination that a driving route of a vehicle includes a tollgate, road information about a road on the driving route; determining, by the controller and based on the road information, a target speed for driving control of the vehicle; and controlling, by the controller, the vehicle to travel at a target rate of acceleration. The target rate of acceleration may be determined based on at least one of: the target speed, a current driving speed of the vehicle, or a distance from the vehicle to the tollgate.

The vehicle control method may further include: receiving, by the controller and from a navigation device via a communication device, an indication of a location of the tollgate; and determining, by the controller and based on the location of the tollgate, that the driving route includes the tollgate.

Obtaining the road information may include: receiving, by the controller, the road information from the navigation device via the communication device.

The road information may include information about at least one of: a curved section in the driving route, or a number of lanes in the driving route.

The vehicle control method may further include: determining, by the controller based on the road information indicating a lack of curved section in the driving route within a threshold distance away from the tollgate, a lane change ratio between a first quantity of lanes, before a lane change location, and a second quantity of lanes after the lane change location. Determining the target speed may include determining the target speed further based on an acceleration multiplier. The acceleration multiplier may be based on a posted speed limit and the lane change ratio.

The vehicle control method may further include: determining, by the controller, the acceleration multiplier to be inversely proportional to the lane change ratio; and determining, by the controller, the target speed based on the acceleration multiplier and the posted speed limit.

Determining the target speed may include: based on the road information indicating that there is a curved section after the tollgate and within a threshold distance away from the tollgate, setting, by the controller, the target speed to a posted speed limit.

Determining the target speed may include: based on the road information indicating that there is a curved section before the tollgate and within a threshold distance away from the tollgate, setting the target speed to be a smaller value of: an exit speed of the curved section, and a posted speed limit.

The target rate of acceleration may be a first target rate of acceleration. Controlling vehicle to travel at the first target rate of acceleration is further based on the distance from the vehicle to the tollgate being within a first threshold distance.

The vehicle control method may further include: based on the distance from the vehicle to the tollgate being within a second threshold distance that is less than the first threshold distance, controlling, by the controller, the vehicle to travel at a second target rate of acceleration. The second target rate of acceleration may be determined based on at least one of: the target speed, the current driving speed of the vehicle, or a control gain.

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram illustrating components of a vehicle control apparatus according to an embodiment of the present disclosure;

FIG. 2 is a block diagram illustrating components of a driving control apparatus according to an embodiment of the present disclosure;

FIG. 3 is a flowchart of a vehicle control method according to an embodiment of the present disclosure;

FIG. 4 illustrates an operational conceptual diagram of a vehicle control apparatus when there is no curved section before an ego vehicle passes through a tollgate and after the ego vehicle passes through the tollgate according to an embodiment of the present disclosure;

FIG. 5 illustrates an operational conceptual diagram of a vehicle control apparatus when there is a curved section before an ego vehicle passes through a tollgate according to an embodiment of the present disclosure.

FIG. 6 is an operational conceptual diagram of a vehicle control apparatus according to an embodiment of the present disclosure.

FIG. 7 is a flowchart of a vehicle control method according to an embodiment of the present disclosure; and

FIG. 8 illustrates a computing system about a vehicle control method according to an embodiment of the present disclosure.

With regard to description of drawings, the same or similar denotations may be used for the same or similar components.

### DETAILED DESCRIPTION

Hereinafter, some embodiments of the present disclosure will be described in detail with reference to the exemplary drawings. In the drawings, the same reference numerals will be used throughout to designate the same or equivalent components. In addition, a detailed description of well-known features or functions will be ruled out in order not to unnecessarily obscure the gist of the present disclosure.

In describing the components of the embodiment according to the present disclosure, terms such as first, second, “A”, “B”, (a), (b), and the like may be used. These terms are only used to distinguish one element from another element, but do not limit the corresponding elements irrespective of the order or priority of the corresponding elements. Furthermore, unless otherwise defined, all terms including technical and scientific terms used herein are to be interpreted as is customary in the art to which this invention belongs. It will be understood that terms used herein should be interpreted as having a meaning that is consistent with their meaning in the context of this disclosure and the relevant art and will not be interpreted in an idealized or overly formal sense unless expressly so defined herein.

A vehicle control apparatus may perform a control algorithm for setting a target speed for driving control of the ego vehicle using information about at least one of a relative distance between the ego vehicle and a preceding vehicle (or a forward vehicle), a relative speed between the ego vehicle and the preceding vehicle (or the forward vehicle), or relative acceleration between the ego vehicle and the preceding vehicle (or the forward vehicle), or any combination thereof and controlling a headway distance to be maintained as a certain value. As an example, such a control algorithm may include a longitudinal advanced driver assistance system (ADAS).

For example, the vehicle control apparatus may control a driving speed of the ego vehicle by further using various pieces of information about driving. As an example, the vehicle control apparatus may obtain navigation information about a driving environment of the ego vehicle from a navigation device and may control a longitudinal driving speed of the ego vehicle to be reduced, based on at least one of a location of a specific point in front of the ego vehicle, road information, crackdown section information, or speed limit information, or any combination thereof.

However, when identifying that there is a tollgate in front of the ego vehicle while performing driving control for the ego vehicle and when not identifying that the number of lanes on the road increases or decreases in a situation where the ego vehicle enters or passes through the tollgate, when performing acceleration control, a critical situation where the ego vehicle collides with the outside occurs or the vehicle control apparatus provides a user with a sense of uncomfortable driving.

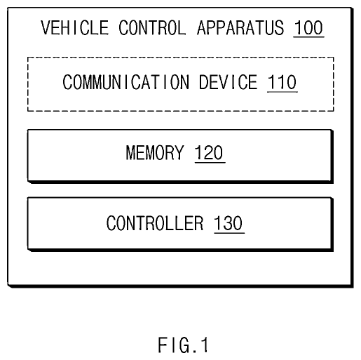

Hereinafter, embodiments of the present disclosure will be described in detail with reference to FIGS. 1 to 8.

FIG. 1 is a block diagram illustrating components of a vehicle control apparatus according to an embodiment of the present disclosure.

According to an embodiment, a vehicle control apparatus 100 may include at least one of a communication device 110, a memory 120, or a controller 130, or any combination thereof. The components of the vehicle control apparatus 100, which are shown in FIG. 1, are illustrative, and embodiments of the present disclosure are not limited thereto. For example, the vehicle control apparatus 100 may further include components (e.g., at least one of an interface, a sensor device, or a display, or a combination thereof) which are not shown in FIG. 1.

According to an embodiment, the communication device 110 may obtain (or identify) various pieces of information used for driving of an ego vehicle.

According to an embodiment, the communication device 110 may assist in establishing a communication channel (e.g., a wireless communication channel) between the vehicle control apparatus 100 and an external device (e.g., a navigation device) and communicating over the established communication channel. For example, the communication device 110 may include one or more communication processors which operate independently of the controller 130 (e.g., an application processor) and support direct (e.g., wired) communication or wireless communication.

For example, the communication device 110 may include a wireless communication module (e.g., a cellular communication module, a short range wireless communication module, or a global navigation satellite system (GNSS) communication module) or a wired communication module (e.g., a local area network (LAN) communication module or a power line communication module). The corresponding communication module among such communication modules may communicate with the external device over a first network (e.g., a short range communication network such as Bluetooth, wireless-fidelity (Wi-Fi) Direct, or infrared data association (IrDA)) or a second network (e.g., a long range communication network such as a legacy cellular network, a fifth generation (5G) network, a next-generation communication network, the Internet, or a computer network (e.g., a local area network (LAN) or a wide area network (WAN))). Such several types of communication modules may be integrated into one component (e.g., a single chip) or may be implemented as a plurality of components (e.g., a plurality of chips) independent of each other. Furthermore, the communication device 110 and the controller 130 may be implemented as a single chip.

For example, the communication device 110 may transmit and receive various pieces of data based on communication with the external device.

As an example, the communication device 110 may receive tollgate information from the navigation device. The tollgate information may include, for example, location information of each of at least one tollgate adjacent to the ego vehicle. The controller 130 may identify a location of the tollgate which is present on a driving route of the ego vehicle, based on the tollgate information.

As an example, the communication device 110 may receive navigation information about a driving situation of the ego vehicle from the navigation device. The navigation information may include, for example, road property information about the road from a current location of the ego vehicle to a specific point after the ego vehicle passes through the tollgate. The road property information may include information about at least one of, for example, whether there is a curved section or the number (e.g., quantity) of lanes in the driving route, or any combination thereof.

According to an embodiment, the memory 120 may store a command or data. For example, the memory 120 may store one or more instructions, when executed by the controller 130, causing the vehicle control apparatus 100 to perform various operations.

For example, the memory 120 and the controller 130 may be implemented as one chipset. The controller 130 may include at least one of a communication processor or a modem.

For example, the memory 120 may store various pieces of information associated with the vehicle control apparatus 100. As an example, the memory 120 may store information about an operation history of the controller 130. As an example, the memory 120 may store information associated with states and/or operations of components (e.g., at least one of an engine control unit (ECU), the communication device 110, or the controller 130, or any combination thereof) of the ego vehicle.

For example, the memory 120 may store at least one mapping table. As an example, the memory 120 may store the mapping table about a lane number change ratio (e.g., a ratio between the quantity of lanes before the change and the quantity of lanes after the change) and an acceleration multiplier (e.g., weight). The acceleration multiplier may be applied (e.g., by multiplying) to a value to determine a proper (e.g., safe) rate of acceleration. The rate of acceleration may be positive (e.g., increasing in speed) or negative (e.g., decreasing in speed). The mapping table may be stored in, for example, a state in which the acceleration multiplier is set to be inversely proportional to a magnitude of the lane number change ratio.

According to an embodiment, the controller 130 may be operatively connected with the communication device 110 and/or the memory 120. For example, the controller 130 may control operations of the communication device 110 and/or the memory 120.

For example, the controller 130 may identify whether there is a tollgate on the driving route of the ego vehicle.

As an example, the controller 130 may identify whether there is a tollgate on a driving route on which the ego vehicle is expected to travel, based on tollgate information including location information of at least one tollgate.

As an example, the controller 130 may receive tollgate information from the navigation device using the communication device 110. The controller 130 may identify whether there is a tollgate on the driving route of the ego vehicle using the received tollgate information.

For example, when there is the tollgate, the controller 130 may identify road property information about the road on the driving route.

As an example, when there is the tollgate on the driving route on which the ego vehicle is expected to travel, the controller 130 may identify road property information of the road before the ego vehicle passes through (or enters) the tollgate and/or road property information of the road to a specific point after the ego vehicle passes through the tollgate.

As an example, the controller 130 may receive road property information from the navigation device using the communication device 110.

As example, the road property information may include information about at least one of whether there is a curved section or the number (e.g., quantity) of lanes in the driving route, or any combination thereof. The controller 130 may identify a lane number change ratio based on the number of the lanes in the driving route included in the road property information.

For example, the controller 130 may identify a target speed for driving control of the ego vehicle based on the road property information.

For example, the controller 130 may identify whether there is a curved section within a specified distance from a tollgate which is present on one point in front of the ego vehicle, based on the road property information. In other words, the controller 130 may identify whether there is a curve section within a specified section on the driving route from the tollgate (e.g., a section within a first distance before the ego vehicle passes through the tollgate and/or a section within a second distance after the ego vehicle passes through the tollgate).

As an example, when it is identified that there is no curved section within the specified distance from the tollgate based on the road property information, the controller 130 may identify a lane number change ratio before and after the ego vehicle enters the tollgate. As an example, when it is identified that there is no curved section in a certain section between the ego vehicle and the tollgate (e.g., within a specified distance from the tollgate), the controller 130 may identify a target speed based on a predetermined safe speed (e.g., 80 km/h), the lane number change ratio, and an acceleration multiplier identified in response to the lane number change ratio. The safe speed may be a posted speed limit associated with the road leading up to the tollgate. The controller 130 may identify, for example, an acceleration multiplier corresponding to the lane number change ratio, based on the mapping table stored in the memory 120. The acceleration multiplier may be set to be inversely proportional to, for example, a magnitude of the lane number change ratio.

As an example, when it is identified that there is the curved section within the specified distance from the tollgate based on the road property information, the controller 130 may identify whether there is the curved section after the ego vehicle passes through the tollgate.

When there is the curved section on the driving route after the ego vehicle passes through the tollgate, the controller 130 may set the target speed to a predetermined safe speed (e.g., 80 km/h) and may control the ego vehicle to travel. In other words, when it is identified that there is curved section after the ego vehicle passes through the tollgate, the controller 130 may determine that the influence of the curved section on the safety of the ego vehicle for passing through the tollgate is very low and may set the target speed to the predetermined safe speed.

When there is the curved section on the driving route before the ego vehicle passes through the tollgate, the controller 130 may set a value of any one of an exit speed of the curved section or the predetermined safe speed to the target speed for driving control (e.g., acceleration control) of the ego vehicle. For example, the controller 130 may set a smaller value between the exit speed of the curved section and the predetermined safe speed to the target speed and may control the ego vehicle to travel.

For example, the controller 130 may control the ego vehicle to travel based on a first target rate of acceleration, which may be positive or negative. The first target rate of acceleration may be determined based on at least one of a real-time driving speed of the ego vehicle, the target speed, or a distance from the current location of the ego vehicle to the tollgate, or any combination thereof, from a point where a remaining distance for the ego vehicle to reach the tollgate is less than or equal to a first threshold distance (e.g., 600 m to 1000 m).

As an example, when a separation distance between the ego vehicle and the tollgate is less than or equal to the first threshold distance, the controller 130 may identify the first target rate of acceleration based on at least some of the above-mentioned parameters for acceleration control and may perform acceleration control of the ego vehicle based on the first target rate of acceleration.

For example, the controller 130 may control the ego vehicle to travel based on second target rate of acceleration identified based on at least one of the real-time driving speed of the ego vehicle, the target speed, or a control gain, or any combination thereof, from a point where the remaining distance for the ego vehicle to reach the tollgate is less than or equal to a second threshold distance (e.g., 300 m) smaller than the first threshold distance to one point after the ego vehicle passes through the tollgate (e.g., a point where the ego vehicle passes 165 m past the tollgate).

As an example, when the separation distance between the ego vehicle and the tollgate is less than or equal to the second threshold distance, before the ego vehicle passes through the tollgate, the controller 130 may perform acceleration control of the ego vehicle based on the second target rate of acceleration.

As an example, when the separation distance between the ego vehicle and the tollgate is less than or equal to a third threshold distance (e.g., 165 m), after the ego vehicle passes the controller 130 may perform through the tollgate, acceleration control of the ego vehicle based on the second target rate of acceleration.

As an example, the controller 130 may reduce a driving speed of the ego vehicle to at a higher rate of deceleration (e.g., more negative amount of acceleration) at the second target rate of acceleration than at the first target rate of acceleration.

The components of the vehicle control apparatus 100, which are shown in FIG. 1, are illustrative, and embodiments of the present disclosure are not limited thereto. For example, the vehicle control apparatus 100 may further include a sensor device (not shown).

For example, the sensor device may include at least one sensor including at least one of a camera, radio detection and ranging (RADAR), or light detection and ranging (LiDAR), or any combination thereof.

For example, the sensor device may directly sense road property information about the road on which the ego vehicle is traveling.

For example, the sensor device may identify information about a driving situation of the ego vehicle (e.g., at least one of a real-time driving speed, driving acceleration, or a driving direction, or any combination thereof).

The above-mentioned operation of the sensor device may be performed by control of the controller 130.

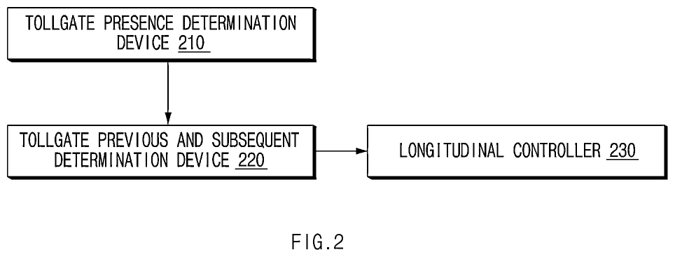

FIG. 2 is a block diagram illustrating components of a vehicle control apparatus according to an embodiment of the present disclosure.

According to an embodiment, a vehicle control apparatus (e.g., a vehicle control apparatus 100 of FIG. 1) may include at least one of a tollgate presence determination device 210, a tollgate previous and subsequent state determination device 220, or a longitudinal controller 230, or any combination thereof.

The components shown in FIG. 2 are illustrative, and embodiments of the present disclosure are not limited thereto. For example, at least some of the components shown in FIG. 2 may be implemented as a part of a controller 130 of FIG. 1 or may be implemented together with the controller 130 as one chip. In other words, at least some of operations of at least one of components which will be described below may be performed by the controller 130 of FIG. 1 (or control of the controller 130).

For example, the tollgate presence determination device 210 may identify whether there is a tollgate.

As an example, the tollgate presence determination device 210 may identify whether there is a tollgate on a driving route of the ego vehicle.

As an example, the tollgate presence determination device 210 may identify tollgate information including location information of the tollgate which is present in front of the ego vehicle on the driving route, based on the tollgate information obtained by means of a navigation device. The tollgate presence determination device 210 may identify, for example, the tollgate which is present on the driving route of the ego vehicle based on the tollgate information.

For example, the tollgate previous and subsequent state determination device 220 may identify information about the road in a specified area before and after the tollgate.

As an example, the tollgate previous and subsequent state determination device 220 may identify the number (e.g., quantity) of lanes on the road in an area adjacent to the tollgate. The tollgate previous and subsequent state determination device 220 may identify, for example, a lane number change ratio.

As an example, the tollgate previous and subsequent state determination device 220 may verify whether there is the tollgate identified by means of the tollgate presence determination device 210.

As an example, when it is verified that there is the tollgate, the tollgate previous and subsequent state determination device 220 may identify road property information within a specified distance from the tollgate based on a location of the tollgate.

As an example, the tollgate previous and subsequent state determination device 220 may identify whether there is a curved section within a specified distance from the tollgate, before the ego vehicle enters the tollgate, based on the road property information.

As an example, the tollgate previous and subsequent state determination device 220 may identify whether there is a curved section after the ego vehicle passes through the tollgate or before the ego vehicle passes through the tollgate, based on the road property information.

As an example, the tollgate previous and subsequent state determination device 220 may identify a safe speed based on the road property information and may identify a target speed based on the safe speed.

For example, when it is identified that there is no curved section within the specified distance from the tollgate, the tollgate previous and subsequent state determination device 220 may identify a lane number change ratio before and after the ego vehicle enters the tollgate. For example, the tollgate previous and subsequent state determination device 220 may identify a target speed based on an acceleration multiplier corresponding to the lane number change ratio before and after the ego vehicle enters the tollgate and a predetermined safe speed. As an example, the tollgate previous and subsequent state determination device 220 may identify a target speed based on multiplying the safe speed by the acceleration multiplier.

For example, when it is identified that there is the curved section within the specified distance from the tollgate, the tollgate previous and subsequent state determination device 220 may identify whether there is the curved section before the ego vehicle passes through the tollgate and after the ego vehicle passes through the tollgate. For example, when there is the curved section after the ego vehicle passes through the tollgate, the tollgate previous and subsequent state determination device 220 may set a predetermined safe speed to the target speed and may control the ego vehicle to travel. For example, when there is the curved section before the ego vehicle passes through the tollgate, the tollgate previous and subsequent state determination device 220 may set a smaller value between a real-time exit speed of the ego vehicle from the curved section and the predetermined safe speed to the target speed and may control the ego vehicle to travel.

As an example, the tollgate previous and subsequent state determination device 220 may identify a distance from a real-time current location of the ego vehicle to the tollgate and may deliver the identified distance to the longitudinal controller 230.

As an example, the tollgate previous and subsequent state determination device 220 may deliver the target speed identified based on at least a portion of road property information to the longitudinal controller 230.

For example, when there is an effective control target (e.g., a tollgate), the longitudinal controller 230 may identify a rate of longitudinal acceleration for the ego vehicle based on a type of the control target, road information, and/or location information.

As an example, the longitudinal controller 230 may collect pieces of information for passing through the tollgate which is present on a driving route of the ego vehicle and may identify a rate of longitudinal acceleration based on at least some of the pieces of collected information.

The longitudinal controller 230 may identify a target rate of acceleration using at least one of, for example, a real-time driving speed of the ego vehicle, the target speed, a distance to the tollgate, or a control gain, or any combination thereof.

The longitudinal controller 230 may perform, for example, acceleration control for the ego vehicle using a target rate of acceleration identified based on different parameters, depending on a magnitude of a separation distance between the ego vehicle and the tollgate.

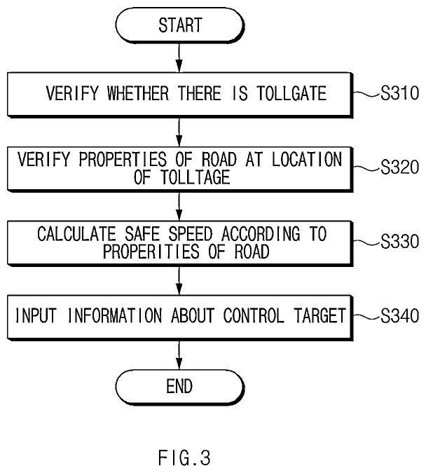

FIG. 3 is a flowchart of a vehicle control method according to an embodiment of the present disclosure.

According to an embodiment, a vehicle control apparatus (e.g., a vehicle control apparatus 100 of FIG. 1) may perform operations disclosed in FIG. 3. For example, at least some of components (e.g., a communication device 110, a memory 120, and/or a controller 130 of FIG. 1) included in the vehicle control apparatus may be configured to perform the operations of FIG. 3.

Operations in S310 to S340 in an embodiment below may be sequentially performed, but are not necessarily sequentially performed. For example, an order of the respective operations may be changed, and at least two operations may be performed in parallel. Furthermore, contents, which correspond to or are duplicated with the contents described above in conjunction with FIG. 3, may be briefly described or omitted.

According to an embodiment, in S310, the vehicle control apparatus may verify whether there is a tollgate.

For example, the vehicle control apparatus may identify whether there is at least one tollgate which is present in front of an ego vehicle on a driving route of the ego vehicle, based on tollgate information received from a navigation device.

For example, the vehicle control apparatus may identify a separation distance between the identified tollgate and the ego vehicle.

According to an embodiment, in S320, the vehicle control apparatus may identify properties of a road at a location of the tollgate.

For example, the vehicle control apparatus may identify road information before the ego vehicle passes through the tollgate on the driving route and/or road property information about the road after the ego vehicle passes through the tollgate, based on road property information received from the navigation device.

For example, the road property information may include information about at least one of whether there is a curved section, a location of the curved section, or the number (e.g., quantity) of lanes in the driving route, or any combination thereof.

According to an embodiment, in S330, the driving control apparatus may calculate a safe speed according to the properties of the road.

For example, the vehicle control apparatus may identify a safe speed and/or a target speed using at least one of whether there is a curved section before the ego vehicle passes through the tollgate, when there is a curved section after the ego vehicle passes through the tollgate, or a lane number change ratio before and after the ego vehicle passes through the tollgate, or any combination thereof, based on the road property information.

According to an embodiment, in S340, the vehicle control apparatus may input information about a control target.

For example, the vehicle control apparatus may deliver pieces of information identified about the control target (e.g., the tollgate) (e.g., at least one of a target speed, a tollgate location, a separation distance between the ego vehicle and the tollgate, or a lane number change ratio in an area adjacent to the tollgate, or any combination thereof) to a longitudinal controller (e.g., a longitudinal controller 230 of FIG. 2).

For example, the vehicle control apparatus may identify a target rate of acceleration based on at least some of the pieces of information delivered to the longitudinal controller and may perform acceleration control for the ego vehicle based on the target rate of acceleration.

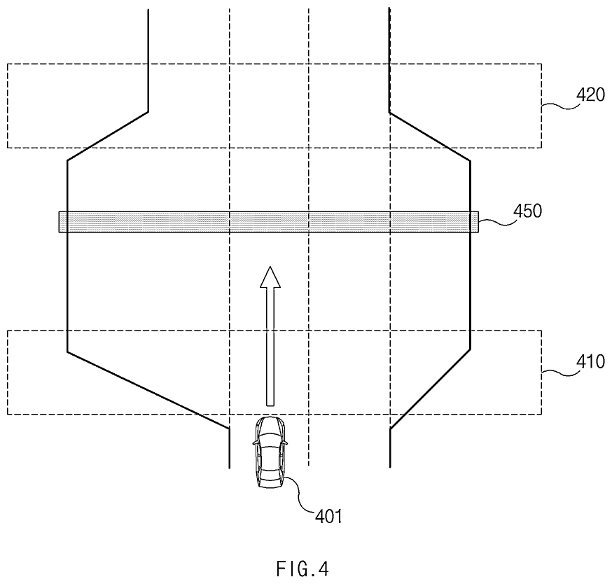

FIG. 4 illustrates an operational conceptual diagram of a vehicle control apparatus when there is no curved section before an ego vehicle passes through a tollgate and after the ego vehicle passes through the tollgate according to an embodiment of the present disclosure.

Referring to FIG. 4, according to an embodiment, a vehicle control apparatus (e.g., a vehicle control apparatus 100 of FIG. 1) may identify a target speed by means of a weight based on an amount of change in the number (e.g., quantity) of lanes in one section before and after an ego vehicle 401 passes through a tollgate 450.

According to an embodiment, the vehicle control apparatus may identify that the number of lanes increases in a first section 410 before the ego vehicle 401 passes through the tollgate 450.

For example, the vehicle control apparatus may identify that the number of lanes increases from 2 to 5 in the first section 410. Thus, the vehicle control apparatus may identify that a lane number change ratio is greater than 2 in the first section 410.

For example, the vehicle control apparatus may identify an acceleration multiplier of 0.9, when the lane number change ratio is greater than 2, based on a mapping table stored in a memory (e.g., a memory 120 of FIG. 1). Such numerical values are illustrative, and embodiments of the present disclosure are not limited thereto.

According to an embodiment, the vehicle control apparatus may identify that the number of lanes decreases in a second section 420 after the ego vehicle 401 passes through the tollgate 450.

For example, the vehicle control apparatus may identify that the number of lanes decreases from 5 to 3 in the second section 420. Thus, the vehicle control apparatus may identify that the lane number change ratio is less than 1 in the second section 420.

For example, the vehicle control apparatus may identify an acceleration multiplier of 1, when the lane number change ratio is less than 1, based on the mapping table stored in the memory. Such numerical values are illustrative, and embodiments of the present disclosure are not limited thereto.

Although not illustrated in FIG. 4, an acceleration multiplier corresponding to when the lane number change ratio is greater than or equal to 1 and is less than 2 may be between 1 and 0.9 (e.g., 0.95). In other words, the acceleration multiplier stored in the mapping table may be set to be inversely proportional to the lane number change ratio. Meanwhile, the above-mentioned numerical values are illustrative, and embodiments of the present disclosure are not limited thereto.

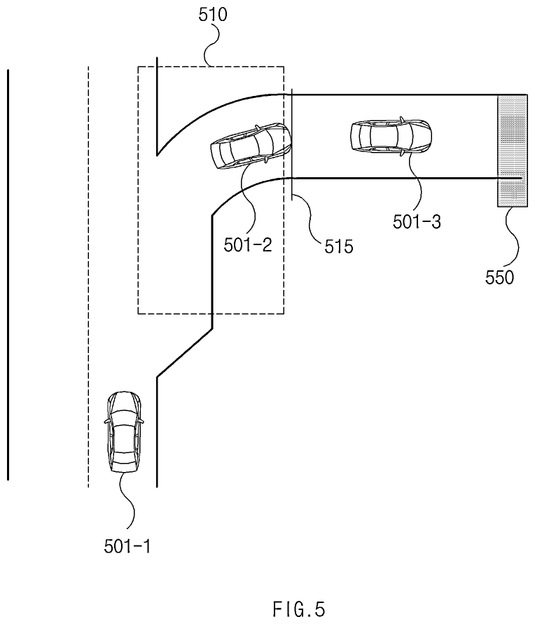

FIG. 5 illustrates an operational conceptual diagram of a vehicle control apparatus when there is a curved section before an ego vehicle passes through a tollgate according to an embodiment of the present disclosure.

Referring to FIG. 5, according to an embodiment, a vehicle control apparatus (e.g., a vehicle control apparatus 100 of FIG. 1) may set a target speed based on an embodiment below, when there is a curve section 510 before an ego vehicle passes through a tollgate 550.

For example, in a situation where the ego vehicle is traveling at a first point 501-1, the vehicle control apparatus may identify that there is the tollgate 550 on a driving route.

In other words, the vehicle control apparatus may identify that the driving route of the ego vehicle includes a route where the ego vehicle passes the tollgate 550 through a curved section 510 from the first point 501-1.

For example, the vehicle control apparatus may perform acceleration control of the ego vehicle at a second point 501-2 included in the curved section 510. For example, the vehicle control apparatus may perform driving control of the ego vehicle at a curved section target speed identified based on at least one of a curvature of the curved section, a section length, driving performance of the ego vehicle, or a real-speed driving speed, or any combination thereof.

For example, the vehicle control apparatus may identify an exit speed of the ego vehicle at a curved section exit point 515. As an example, the vehicle control apparatus may identify an exit speed of the ego vehicle at the curved section exit point 515 in real time.

For example, the vehicle control apparatus may compare the curved section exit speed with a safe speed at a third point 501-3 after the ego vehicle exits (or deviates) from the curved section 510. As an example, the vehicle control apparatus may compare a predetermined safe speed (e.g., 80 km/h) with the curved section exit speed.

As an example, when the curved section exit speed is smaller than the predetermined safe speed, the vehicle control apparatus may set the curved section exit speed to a target speed.

As an example, when the curved section exit speed is greater than the predetermined safe speed, the vehicle control apparatus may set the predetermined safe speed to the target speed.

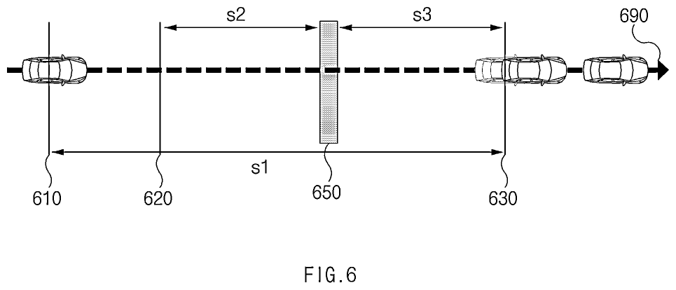

FIG. 6 is an operational conceptual diagram of a vehicle control apparatus according to an embodiment of the present disclosure.

Referring to FIG. 6, according to an embodiment, when identifying whether there is a tollgate 650, a vehicle control apparatus (e.g., a vehicle control apparatus 100 of FIG. 1) may perform acceleration control for an ego vehicle based on various pieces of information.

According to an embodiment, when there is the tollgate 650 on a driving route of the ego vehicle, the vehicle control apparatus may set a target speed based on at least one of tollgate information or road property information, or any combination thereof and may perform acceleration control for the ego vehicle based on a target rate of acceleration identified based on at least one of the target speed, a real-time driving speed of the ego vehicle, a distance to the tollgate 650, or a control gain, or any combination thereof.

According to an embodiment, when identifying there is the tollgate 650, the vehicle control apparatus may identify a target rate of acceleration for acceleration control during a acceleration control duration s1. For example, the vehicle control apparatus may control the ego vehicle based on a driving direction 690 in which the ego vehicle passes through the tollgate 650.

For example, the vehicle control apparatus may perform acceleration control for the ego vehicle based on a first target rate of acceleration a_{req1} based on Equation 1 below during a duration s2 from a first point 610 spaced apart by a first threshold distance (e.g., 600 m to 1000 m) from the tollgate 650 to a second point 620 spaced apart by a second threshold distance (e.g., 300 m).

$${a}_{req 1} = \frac{{V}_{t a r}^{2} - {V}_{s u b}^{2}}{2 \times {S}_{d i s t a n c e}} \qquad [ Equation 1 ]$$

For example, the vehicle control apparatus may perform acceleration control for the ego vehicle based on the first target rate of acceleration a_{req1} identified based on a target speed Vₜₐᵣ, a real-time driving speed Vsub of the ego vehicle, and a separation distance S_{distance} between the ego vehicle and the tollgate 650.

For example, the vehicle control apparatus may perform acceleration control for the ego vehicle based on a second target rate of acceleration a_{req2} based on Equation 2 below during a second duration s2 from a second point 620 spaced apart by a second threshold distance (e.g., 300 m) from the tollgate 650 to the tollgate 650 and a third duration s3 from the tollgate 650 to a third point 630 through which the ego vehicle passes by a third threshold distance (e.g., 165 m).

$${a}_{req 2} = ( {V}_{t a r} - {V}_{s u b} ) \times gain \qquad [ Equation 2 ]$$

For example, the vehicle control apparatus may perform acceleration control for the ego vehicle based on a second target acceleration a_{req2} identified based on the target speed Vₜₐᵣ, the real-time driving speed Vsub of the ego vehicle, and a control gain. The control gain may be, for example, a parameter configured to calculate a target rate of acceleration to be larger. The control gain may be, for example, a predetermined value, which may be a setting value changeable by a user and/or a developer.

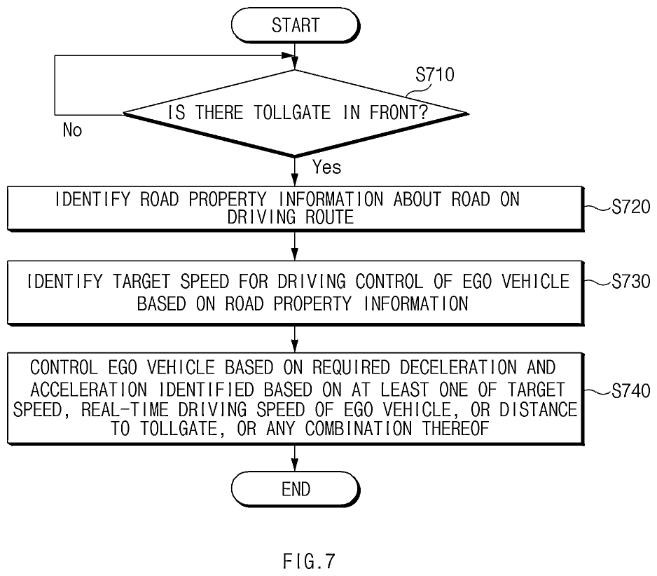

FIG. 7 is a flowchart of a vehicle control method according to an embodiment of the present disclosure.

According to an embodiment, a vehicle control apparatus (e.g., a vehicle control apparatus 100 of FIG. 1) may perform operations disclosed in FIG. 7. For example, at least some of components (e.g., a communication device 110, a memory 120, and/or a controller 130 of FIG. 1) included in the vehicle control apparatus may be configured to perform the operations of FIG. 7.

Operations in S710 to S740 in an embodiment below may be sequentially performed, but are not necessarily sequentially performed. For example, an order of the respective operations may be changed, and at least two operations may be performed in parallel. Furthermore, contents, which correspond to or are duplicated with the contents described above in conjunction with FIG. 7, may be briefly described or omitted.

According to an embodiment, in S710, the vehicle control apparatus may identify whether there is a tollgate.

For example, the vehicle control apparatus may identify at least one of whether there is a tollgate in front of an ego vehicle on a driving route of the ego vehicle or a remaining distance to the tollgate, or any combination thereof, using tollgate information received from a navigation device through a communication device.

According to an embodiment, in S720, the vehicle control apparatus may identify road property information about the road on the driving route.

For example, the vehicle control apparatus may receive road property information of an area adjacent to the tollgate on the driving route from the navigation device through the communication device.

For example, the road property information may include information about at least one of whether there is a curved section, a location of the curved section, or the number of lanes in the driving route, or any combination thereof.

According to an embodiment, in S730, the vehicle control apparatus may identify a target speed for driving control of the ego vehicle based on the road property information.

For example, the vehicle control apparatus may identify a target speed using at least one of whether there is a curved section, a location of the curved section, a lane number change ratio in the driving route, an acceleration multiplier corresponding to the lane number change ratio, or a curved section exit speed, or any combination thereof.

According to an embodiment, in S740, the vehicle control apparatus may control the ego vehicle based on a target rate of acceleration identified based on at least one of the target speed, a real-time driving speed of the ego vehicle, or a distance to the tollgate, or any combination thereof.

For example, the vehicle control apparatus may decelerate the host vehicle based on the target rate of acceleration.

For example, the vehicle control apparatus may decelerate the ego vehicle based on a first target rate of acceleration identified based on at least one of the real-time driving speed of the ego vehicle, the target speed, or the distance to the tollgate, or any combination thereof, from a point where a remaining distance for the ego vehicle to reach the tollgate is less than or equal to a first threshold distance (e.g., 600 m to 1000 m).

For example, the vehicle control apparatus may decelerate the ego vehicle based on a second target rate of acceleration identified based on at least one of the real-time driving speed of the ego vehicle, the target speed, or a control gain, or any combination thereof, from a point where the remaining distance for the ego vehicle to reach the tollgate is less than or equal to a second threshold distance (e.g., 300 m) smaller than the first threshold distance to one point after the ego vehicle passes through the tollgate (e.g., a point where the ego vehicle passes 165 m through the tollgate). The control gain may be, for example, a parameter configured to calculate a target rate of acceleration to be larger. The control gain may be a predetermined value, which may be a setting value changeable by a user and/or a developer.

For example, a detailed embodiment in which the vehicle control apparatus identifies the target speed may be replaced with the above-mentioned description of FIG. 1.

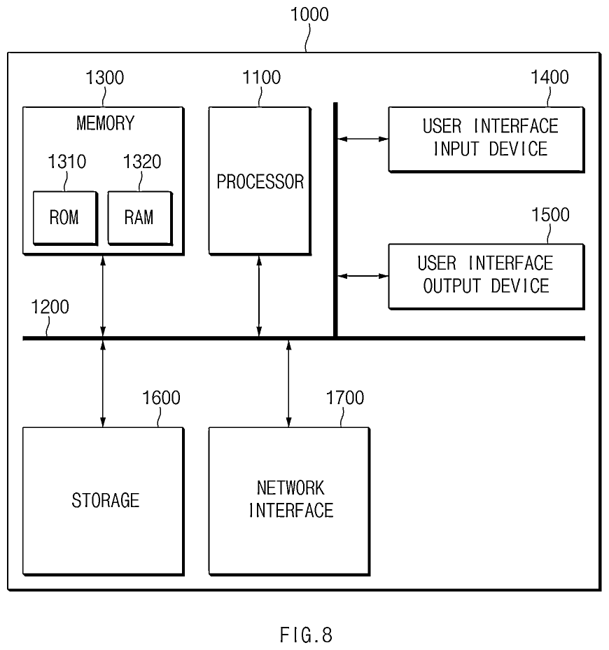

FIG. 8 illustrates a computing system about a vehicle control method according to an embodiment of the present disclosure.

Referring to FIG. 8, a computing system 1000 about the vehicle control method may include at least one processor 1100, a memory 1300, a user interface input device 1400, a user interface output device 1500, storage 1600, and a network interface 1700, which are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320.

Accordingly, the operations of the method or algorithm described in connection with the embodiments disclosed in the specification may be directly implemented with a hardware module, a software module, or a combination of the hardware module and the software module, which is executed by the processor 1100. The software module may reside on a storage medium (that is, the memory 1300 and/or the storage 1600) such as a RAM, a flash memory, a ROM, an EPROM, an EEPROM, a register, a hard disc, a removable disk, and a CD-ROM.

The exemplary storage medium may be coupled to the processor 1100. The processor 1100 may read out information from the storage medium and may write information in the storage medium. Alternatively, the storage medium may be integrated with the processor 1100. The processor and the storage medium may reside in an application specific integrated circuit (ASIC). The ASIC may reside within a user terminal. In another case, the processor and the storage medium may reside in the user terminal as separate components.

A description will be given of effects of the vehicle control apparatus and the method thereof according to an embodiment of the present disclosure.

According to at least one of embodiments of the present disclosure, the vehicle control apparatus may identify a tollgate which is present in front of an ego vehicle and may set a safe target speed depending on a road environment in an area adjacent to the tollgate (e.g., an area within a specified distance before the ego vehicle passes through the tollgate and after the ego vehicle passes through the tollgate), thus performing driving speed control which is efficient and has high safety.

Furthermore, according to at least one of embodiments of the present disclosure, the vehicle control apparatus may safely control the ego vehicle in a level which does not interfere with the traffic flow of surrounding vehicles adjacent to the ego vehicle.

Furthermore, according to at least one of embodiments of the present disclosure, the vehicle control apparatus may continuously control a driving speed of the vehicle without pausing autonomous driving control and/or SCC control, even after the ego vehicle passes through the tollgate, thus providing a user with a vehicle driving control function which is safe and has high continuity.

In addition, various effects ascertained directly or indirectly through the present disclosure may be provided.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

Therefore, embodiments of the present disclosure are not intended to limit the technical spirit of the present disclosure, but provided only for the illustrative purpose. The scope of the present disclosure should be construed on the basis of the accompanying claims, and all the technical ideas within the scope equivalent to the claims should be included in the scope of the present disclosure.

What is claimed is:

1. A vehicle control apparatus comprising:
a controller; and
memory storing instructions that, when executed by the controller, cause the vehicle control apparatus to:
obtain, based on a determination that a driving route of a vehicle comprises a tollgate, road information about a road on the driving route;
determine, based on the road information, a target speed for driving control of the vehicle; and
control the vehicle to travel at a target rate of acceleration, wherein the target rate of acceleration is determined based on at least one of: the target speed, a current driving speed of the vehicle, or a distance from the vehicle to the tollgate.

2. The vehicle control apparatus of claim 1, further comprising:
a communication device,
wherein the instructions, when executed by the controller, further cause the vehicle control apparatus to:
receive, from a navigation device via the communication device, an indication of a location of the tollgate; and
determine, based on the location of the tollgate, that the driving route comprises the tollgate.

3. The vehicle control apparatus of claim 2, wherein the instructions, when executed by the controller, cause the vehicle control apparatus to obtain the road information by receiving the road information from the navigation device via the communication device.

4. The vehicle control apparatus of claim 1, wherein the road information comprises information about at least one of:
a curved section in the driving route, or
a number of lanes in the driving route.

5. The vehicle control apparatus of claim 1, wherein the instructions, when executed by the controller, further cause the vehicle control apparatus to:
determine, based on the road information indicating a lack of curved section in the driving route within a threshold distance away from the tollgate, a lane change ratio between a first quantity of lanes, before a lane change location, and a second quantity of lanes after the lane change location, and
wherein the instructions, when executed by the controller, cause the vehicle control apparatus to determine the target speed further based on an acceleration multiplier, wherein the acceleration multiplier is based on a posted speed limit and the lane change ratio.

6. The vehicle control apparatus of claim 5, wherein the instructions, when executed by the controller, further cause the vehicle control apparatus to store a mapping table that maps the lane change ratio to the acceleration multiplier, and
wherein the instructions, when executed by the controller, further cause the vehicle control apparatus to:
determine the acceleration multiplier to be inversely proportional to the lane change ratio; and
determine the target speed based on the acceleration multiplier and the posted speed limit.

7. The vehicle control apparatus of claim 1, wherein the instructions, when executed by the controller, cause the vehicle control apparatus to determine the target speed by:
based on the road information indicating that there is a curved section after the tollgate and within a threshold distance away from the tollgate, setting the target speed to a posted speed limit.

8. The vehicle control apparatus of claim 1, wherein the instructions, when executed by the controller, cause the vehicle control apparatus to determine the target speed by:
based on the road information indicating that there is a curved section before the tollgate and within a threshold distance away from the tollgate, setting the target speed to be a smaller value of:
an exit speed of the curved section, and
a posted speed limit.

9. The vehicle control apparatus of claim 1, wherein the target rate of acceleration is a first target rate of acceleration, and wherein the instructions, when executed by the controller, cause the vehicle control apparatus to control the vehicle to travel at the first target rate of acceleration further based on the distance from the vehicle to the tollgate being within a first threshold distance.

10. The vehicle control apparatus of claim 9, wherein the instructions, when executed by the controller, further cause the vehicle control apparatus to:
based on the distance from the vehicle to the tollgate being within a second threshold distance that is less than the first threshold distance, control the vehicle to travel at a second target rate of acceleration, wherein the second target rate of acceleration is determined based on at least one of: the target speed, the current driving speed of the vehicle, or a control gain.

11. A vehicle control method comprising:
obtaining, by a controller and based on a determination that a driving route of a vehicle comprises a tollgate, road information about a road on the driving route;
determining, by the controller and based on the road information, a target speed for driving control of the vehicle; and
controlling, by the controller, the vehicle to travel at a target rate of acceleration, wherein the target rate of acceleration is determined based on at least one of: the target speed, a current driving speed of the vehicle, or a distance from the vehicle to the tollgate.

12. The vehicle control method of claim 11, further comprising:
receiving, by the controller and from a navigation device via a communication device, an indication of a location of the tollgate; and
determining, by the controller and based on the location of the tollgate, that the driving route comprises the tollgate.

13. The vehicle control method of claim 12, wherein the obtaining of the road information comprises:
receiving, by the controller, the road information from the navigation device via the communication device.

14. The vehicle control method of claim 11, wherein the road information comprises information about at least one of:
a curved section in the driving route, or
a number of lanes in the driving route.

15. The vehicle control method of claim 11, further comprises:
determining, by the controller based on the road information indicating a lack of curved section in the driving route within a threshold distance away from the tollgate, a lane change ratio between a first quantity of lanes, before a lane change location, and a second quantity of lanes after the lane change location, and
wherein the determining of the target speed comprises determining the target speed further based on an acceleration multiplier, wherein the acceleration multiplier is based on a posted speed limit and the lane change ratio.

16. The vehicle control method of claim 15, further comprising:
determining, by the controller, the acceleration multiplier to be inversely proportional to the lane change ratio; and
determining, by the controller, the target speed based on the acceleration multiplier and the posted speed limit.

17. The vehicle control method of claim 11, wherein the determining of the target speed comprises:
based on the road information indicating that there is a curved section after the tollgate and within a threshold distance away from the tollgate, setting, by the controller, the target speed to a posted speed limit.

18. The vehicle control method of claim 11, wherein the determining of the target speed comprises:
based on the road information indicating that there is a curved section before the tollgate and within a threshold distance away from the tollgate, setting the target speed to be a smaller value of:
an exit speed of the curved section, and
a posted speed limit.

19. The vehicle control method of claim 11, wherein the target acceleration is a first target rate of acceleration, and wherein the controlling of the vehicle to travel at the first target rate of acceleration is further based on the distance from the vehicle to the tollgate being within a first threshold distance.

20. The vehicle control method of claim 19, further comprising:
based on the distance from the vehicle to the tollgate being within a second threshold distance that is less than the first threshold distance, controlling, by the controller, the vehicle to travel at a second target rate of acceleration, wherein the second target rate of acceleration is determined based on at least one of: the target speed, the current driving speed of the vehicle, or a control gain.
